(19) United States
(12) Patent Application Publication
(10) Pub. No.: US 2024/0278969 A1
(43) Pub. Date: Aug. 22, 2024

(54) Resealable Packaging for Crystallized Cannabis Products

(71) Applicant: Vapor Oil Technology llc, Jackson, MI (US)

(72) Inventor: Chad Arthur Carey, Phoenix, AZ (US)

(73) Assignee: Vapor Oil Technology llc, Jackson, MI (US)

(21) Appl. No.: 18/637,230

(22) Filed: Apr. 16, 2024

(51) Int. Cl. B65D 75/30; B65D 25/54; B65D 83/06

(52) U.S. Cl. CPC B65D 75/30; B65D 25/54; B65D 83/06; B65D 2575/586

(57) ABSTRACT

A method and apparatus for sealing and resealing crystalline cannabinoids. The method includes providing a resealable package having a top edge, a metallic back layer with a back layer periphery and a front layer having a front layer periphery, at least a portion of the front layer being non-opaque to reveal contents of the resealable package. Next, providing crystalline cannabinoids between the back layer and the front layer. And then sealing the crystalline cannabinoids between the back layer and the front layer along the front layer periphery and back layer periphery. The back layer and the front layer define a top edge having two bonding corners, the top edge defines a tear line extending across the top edge, the two bonding corners and the top edge define a dispensing slot between the two bonding corners for pouring crystalline cannabinoids.

### FIELD OF THE INVENTION

The present invention relates to more efficient ways of packaging crystallized consumer products, and more particularly this invention relates to packaging and dispensing crystallized cannabinoids.

### BACKGROUND OF THE INVENTION

Cannabinoids include synthetic cannabinoids that are synthesized in a lab. Phytocannabinoids are produced by plants such as Cannabis sativa l. Endocannabinoids are produced within the bodies of mammals including humans and are active biochemicals of the endocannabinoid system in humans. There are at least a hundred known cannabinoids. Many can be derived from Cannabis sativa l.

Orally ingested cannabinoids are reduced, transmuted, or otherwise deactivated due to the action of the hepatic system, and particularly first pass metabolism, which utilizes cytochrome p450 oxidative enzymes and other enzymes to neutralize, transform, or deactivate both synthetic cannabinoids and phytocannabinoids that can be consumed orally. This eliminates a majority of the cannabinoid activity in-vivo. Accordingly, a more efficacious manner of ingesting cannabinoids is desired.

Pulmonary delivery of cannabinoids is known to bypass the digestive tract and thus hepatic first pass metabolism does not significantly reduce the efficacy of the cannabinoids. Smoking cannabinoids is thus a common method of delivering cannabinoids. It is common for people to smoke Cannabis flower, flower infused by concentrated cannabinoids, and other plant based material combined with concentrated, isolated or distilled cannabinoids.

A benefit of pulmonary delivery via smoking includes the transformation of acid form cannabinoids to non-acid forms due to the heat. For example, when tetrahydrocannabinol (THC-A) in its natural acid form is smoked, the result is that tetrahydrocannabinol in its non-acid form (THC) is delivered into the blood stream of the smoker. This result is shared with many cannabinoids that are decarboxylated with heat.

Δ-8-tetrahydrocannabinol and other tetrahydrocannabinol isomers, including Δ-10-tetrahydrocannabinol, Δ-10-tetrahydrocannabinol and Δ-6A-tetrahydrocannabinol each have acid and non-acid forms capable of pulmonary delivery.

An advantage of providing packaging for acid form (non-decarboxylated) cannabinoids is that they crystallize more easily than non-acid forms. Another advantage is that crystallized cannabinoids in acid form are shelf stable. Yet another advantage is that the crystallized cannabinoids may be granulated or powdered to flow easily. There are also regulatory advantages in many jurisdictions of the naturally occurring acid forms of cannabinoids. Cannabinoids naturally found in Hemp (Cannabis Sativa L) have some regulatory advantages.

Many packages for crystallized forms of cannabinoids utilize a plastic jar with a threaded lid. The crystals are not easily dispensed with consistence in volume as it is difficult to regulate the flow. Further crystals can easily become lodged between the threads of the lid and threads of the the jar. Also, it is easy to spill. When a sip lock bag is used, crystals can lodge in the zip closure of the bag and become stuck, and inhibit function of the zip closure. Additionally pouring crystals over a zip closure can make regulating flow quite difficult.

What is desired is a way of providing and using a resealable package for crystallized granular material that is easy to regulate flow when poured, easily reseals, and does not easily spill or waste the crystallized material when handled.

### SUMMARY OF THE INVENTION

A method and apparatus for sealing and resealing crystalline materials in a resealable package that is optimized for dispensing crystalline material and being resealable to not waste, spill or degrade the enclosed crystalline materials. Preferably, the crystalline material is a crystallized cannabinoid distillate or isolate. The crystalline material can alternatively comprise combinations of various cannabinoid distillates or isolates. Cannabinoids are defined herein as molecules that have the ability to agonize or antagonize the CB1 or CB2 cannabinoid receptors in humans.

A exemplary method in accordance with the present invention includes providing a resealable package having a top edge, a metallic back layer and generally transparent front layer. The back layer has a back layer periphery and a front layer having a front layer periphery which bond to each other to seal crystallized material there between.

At least a portion of the front layer is non-opaque, or transparent, to reveal contents of the resealable package. The back layer is opaque or reflective to inhibit transmission of light which may degrade, oxidize, or otherwise transform crystallized cannabinoids.

Next, the method provides crystalline cannabinoids between the back layer and the front layer. And then sealing the crystalline cannabinoids between the back layer and the front layer along the front layer periphery and back layer periphery. The back layer and the front layer define a top edge having two bonding corners, the top edge defines a tear line extending across the top edge, the two bonding corners and the top edge define a dispensing slot between the two bonding corners.

A user can selectively choose to orient the resealable packaging to either reveal the contents or to inhibit solar oxidation. Further, having the metallic back can reflect ambient light within the packaging to make the crystallized materials enclosed in the packaging more visible when the packaging is properly oriented for viewing.

The method includes tearing or shearing the top edge along the tear line to expose the dispensing slot to enable the enclosed crystalline cannabinoids to be precisely dispensed via the dispensing slot, and then folding the resealable package to reseal it.

The bonding corners provide a rigid planar bonding surface surrounding the dispensing slot and each bonding corner forms a triangular shape to improve rigidity of the top edge, especially near the dispensing slot.

The use of the rigid planar bonding surface surrounding the dispensing slot enables the slot to have a smooth and texture free slot surface. This smooth slot surface is designed to consistently enable flow of the crystalline material from the resealable package. An advantage of the smooth slot surface is that it eliminates any need for a zipper type seal, which has textured tracks that can trap crystalline granules and make dispensing crystalline granules difficult to regulate.

In one embodiment of the invention the triangular shape bonding corners maintain the shape of a right triangle with the right angle on the periphery of the top edge of the resealable package. In this way acute angles of each of the bonding corners point towards each other on opposing sides of the smooth slot surface. Having the bonding corners point acute angles towards each other creates a pinch point at the slot so that flow of granular material can be closely regulated.

### BRIEF DESCRIPTION OF THE DRAWINGS

FIG. 1 is front view of the resealable packaging of the present invention.

FIG. 2 is a perspective view of the resealable packaging of FIG. 1 having a transparent front layer enclosing crystallized cannabinoids.

FIG. 3 is a perspective view of the the resealable packaging of FIG. 2 with a top edge in a folded orientation.

FIG. 4 is a flow chart of a method of the present invention.

### DETAILED DESCRIPTION

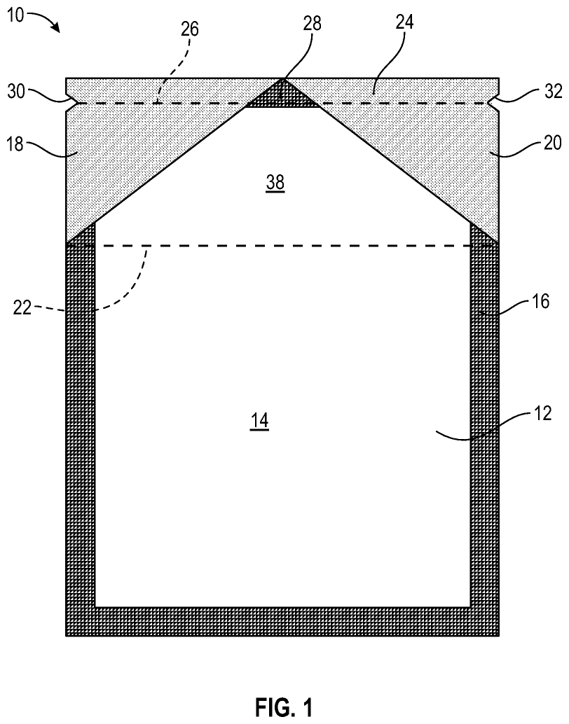

FIG. 1 is a resealable package generally designated with the reference numeral 10. The package 10 is particularly useful for storing and dispensing crystalline substances, such as crystalline cannabinoids.

The package 10 includes a front layer 12 and a back layer 14 that is visible through at least a portion of the front layer 12.

The back layer 14 is opaque, so it inhibits transmission of light. It is made of a metallic foil having an inner coating of synthetic resin made from ethylene. The synthetic resin may be transparent so that the back layer 14 reflects light incident on it through the front layer 12.

The back layer 14 has a back layer periphery surrounding the back layer 14 for bonding to a front layer 12. Together the back layer periphery and the front layer periphery cooperate to form a package periphery 16. The package 10, as shown, is generally rectangular in shape and the package periphery 16 is defines outer edges of the generally rectangular shape. The package periphery 16 has a texture, i.e. dimpled surface to maximize adhesion between the back layer periphery and the front layer periphery.

The front layer 12 has two bonding corners 18 and 20. The two bonding corners 18 and 20 are triangular and have textured surfaces, i.e. dimpled to improve rigidity. The bonding corners adhere to the back layer 14 to define a dispensing slot 28. The bonding corners 18 and 20 also improve rigidity in the proximity of the dispensing slot 28. The bonding corners 18 and 20 also form a funnel shape depicted having a triangular cross section that guides crystallized material towards the dispensing slot 28 when the resealable package 10 is inverted for dispensing the crystallized material through the dispensing slot 28.

The bonding corners 18 and 20 seal the front layer 12 to the back layer 14 and the bonding corners 18 and 20 cooperate to form a rigid flap that folds along the line 22 upon the resealable package 10 to enable the resealable package 10 to reseal after opening.

Preferably the metallic foil of the back layer is manufactured from aluminum to enable plastic deformation, to improve overall rigidity of the package 10, and to reflect light incident on it through the front layer 12. Reflecting light is important to enable viewing of the contents of the package 10 through the front layer 12, and to enable rapid estimation of the volume of the contents.

When the contents include crystalline materials, such as crystalline tetrahydrocannabinolic acid (THC-A), the incident light and reflected light cooperation to enable the crystalline cannabinoids to shine like diamonds, providing consumer recognition and appeal.

In one embodiment, the metallic foil has a thickness of between 0.1 millimeter (mm) to 1.5 mm to enable a sufficient degree of plastic deformation of the resealable package. More preferably, the thickness is between 0.5 and 1.0 mm.

The package 10 has a top edge 24 which includes the two bonding corners, a center and a line 26 extending across the top edge 24. The two generally triangular bonding corners 18 and 20 define a dispensing slot 28 there between. The generally triangular bonding corners 18 and 20 bond to the front layer 12 and the back layer 14 to form a top flap 30 defined above the line 22.

The line 26 has two ends 30 and 32. Each end defines and intersects with an indent defined on the top edge to enable tearing or shearing the top edge 24 from the package 10. The indents at the ends 30 and 32 are formed in a portion of the generally triangular bonding corners 18 and 20, respectively. In this way the triangular bonding corners 18 and 20 define portions of the dispensing slot 28, to assure rigidity of the dispensing slot 28 on two sides.

The top flap 38 includes the triangular bonding corners 18 and 20, the top edge 24 and the dispensing slot 28. The top flap 38 folds along the folding line 22 to reseal the resealable package 10 when the top edge 24 is sheared along the line 26 between the indents at the ends 20 and 32 The top flap 38 can also fold along the folding line 22 before the top edge 24 is sheared to make a more compact packaging

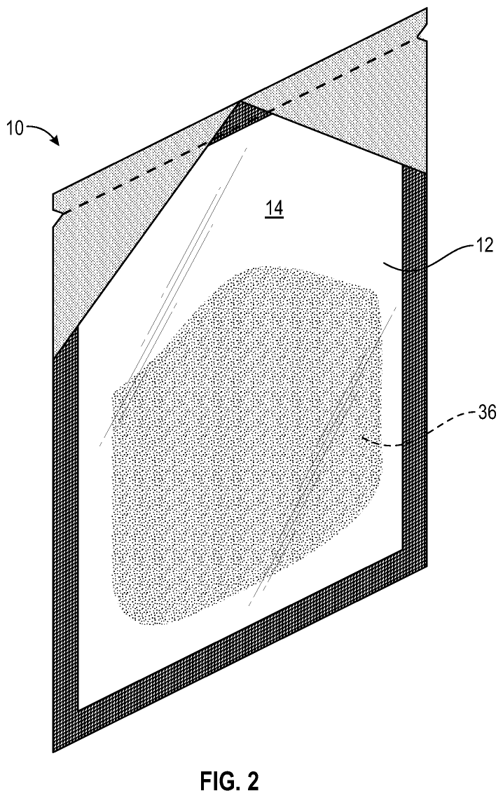

FIG. 2 is the resealable package 10 containing crystalline material 36. Preferably the crystalline material 36 is crystalline cannabinoids sealed between the front layer 12 and a back layer 14. The front layer 12 is non-opaque so that the crystalline material 36 is visible through at least a portion of the front layer 12. The back layer 14 is reflective to enable incident light to highlight and reflect from the crystalline material 36. Preferably the crystalline material is granular, have a size approximating granulated table salt or sugar, which is between 0.150 to 1.4 millimeters average diameter. More preferably, the average crystal size is between 0.2 to 0.5 mm in diameter.

The crystalline material includes crystalline cannabinoids. Cannabinoids are defined as tetrahydrocannabinol, cannabidiol, tetrahydrocannabinolic acid, cannabidiolic acid, various isomers of these molecules, other currently known cannabinoids, and combinations thereof. The term cannabinoid should be broadly understood as any cannabinoid found naturally in Cannabis sativa l., and engineered isomers thereof. The term cannabinoid should also be understood to include acid and non-acid forms of naturally occurring cannabinoids.

In one embodiment, the resealable package 10 has a fully transparent front layer 12 to reveal the crystalline cannabinoids on one side of the resealable package 10. In another embodiment, the resealable package 10 encloses crystalline cannabinoids and the front layer 12 is translucent and tinted to reveal the crystalline cannabinoids with an aesthetically desirable tint.

In another embodiment of the invention, the resealable package 10 encloses crystalline materials 36 and the front layer 14 is translucent and coated with a ultraviolet filter to reveal the crystalline cannabinoids with an aesthetically desirable tint, and to filter ultraviolet light that might degrade the crystalline materials 36.

In yet another embodiment of the invention, the back layer 38 is reflective to inhibit entry of light into the resealable package 10 from the back side. This enables the package 10 to be left with the back layer 38 directed to block ambient light and the front layer directed to a table or non-illuminated planar surface.

The resealable package 10 is coated with ethylene, which is linear low density polyethylene, and the line includes and is defined in high density polyethylene to enable structural integrity when folding along the line. In another embodiment, the ethylene is high density polyethylene and the line is defined in the high density polyethylene to enable folding along the line numerous times without deforming or failing to function. In another embodiment, the front layer is manufactured from polyethylene terephthalate (PET), which resists chemical interactions with crystallized cannabinoids. It can be appreciated that other non-reactive materials can be used to seal the crystallized material I.e. cannabinoids in the resealable package 10.

The resealable package, according to a preferred embodiment, has a transparent front layer is transparent to reveal crystallized cannabinoids within the resealable packaging. The back layer includes transparent polyethylene and the metallic coating to enable the metallic coating to reflect light within the resealable packaging to highlight the crystallized cannabinoids in the packaging.

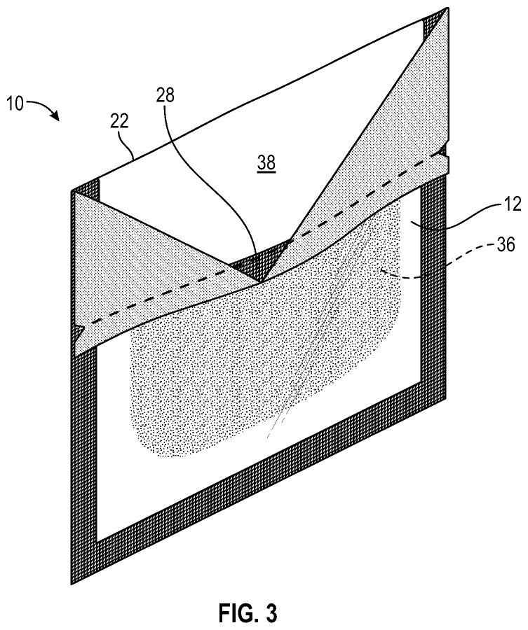

FIG. 3 shows the top flap 38 folding along the line 22 to seal against the front face 12 of the resealable package 10. In this folded orientation the edge 22 forms a seal so that crystalline material 36 can not escape through the slot 28, when the top 24 is sheared. The edge 22 forms a seal also when the top 24 is not yet sheared to maintain the crystalline material 36 in view.

It can be appreciated that there are other ways that can be used to improve rigidity of the flap that folds on the line 22 and that the materials of the package 10 can vary with thickness, transparency, and reflectivity.

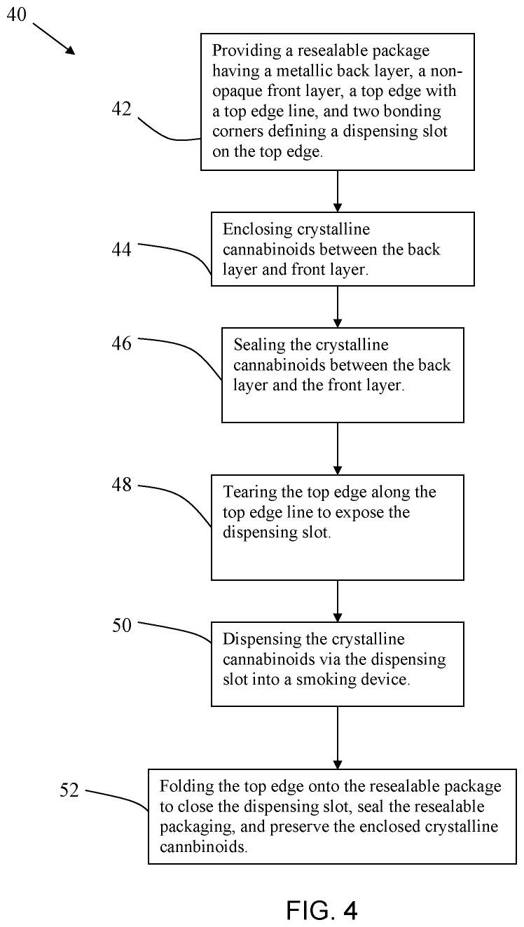

FIG. 4. is a method of the present invention generally designated with the reference numeral 40. The method 40 includes the step 42 of providing a resealable package having a metallic back layer, an opaque front layer, a top edge with a center line and two bonding corners defining a dispensing slot. The bonding corners can be triangular, but square and other geometries may be engineered to work.

The method 40 further includes the step 44 for providing crystalline cannabinoids between the back layer and the front layer. Next, the step 46 seals the crystalline cannabinoids between the back layer and the front layer. In order to dispense the crystalline cannabinoids in a measured way without losses, the step 48 includes shearing or tearing the top edge along the line 22 to expose the dispensing slot. The step 50 includes inverting the resealable package so that gravity draws the crystalline cannabinoids towards the dispensing slot and carefully dispensing the crystalline cannabinoids via the dispensing slot into a smoking device such as a marijuana cigarette, or in the bowl of a pipe containing Cannabis biomass, herbal biomass, tobacco, or combinations thereof. The crystalline cannabinoids can also be smoked directly without adding to a herbal base.

After at least some of the crystalline cannabinoids are dispensed, the step 52 folds the top edge onto the resealable package to seal the resealable package along the line 22 and to close the dispensing slot and inhibit flow of crystalline cannabinoids from the resealable package to the dispensing slot. The seal inhibits airflow to preserve the enclosed crystalline cannabinoids.

The method includes tearing the top edge along the tear line to expose the dispensing slot to enable the enclosed crystalline cannabinoids to be precisely dispensed via the dispensing slot, and then folding the resealable package to reseal it.

It is important to note that the present invention defines the dispensing slot with rigid materials to enable precise and waste free dispensing of high value crystalline granulated material via the dispensing slot, and sealing the resealable package numerous times without waste or degradation of the crystalline material. While the present invention is expressed by way of example above, the appended claims specifically describe the meets and bounds of the invention.

I claim:

1. A resealable package for crystalline cannabinoids, comprising:
a back layer, a front layer and a top portion with a dispensing slot;
the back layer being of a metallic foil having an inner coating of synthetic resin made from ethylene, the back layer is opaque for blocking light, and the front layer being at least partially transparent to enable viewing of crystalline cannabinoids in the resealable package, the back layer and the front layer each have a periphery that bonds the back layer and the front layer together;
two generally triangular bonding corners formed on the top portion, the two binding corners provide rigidity to the top portion, define a funnel there between, and define portions of the dispensing slot; and
the two bonding corners are sufficiently rigid to form a flap that selectively folds upon the resealable package to reseal after use.

2. The resealable package as set forth in claim 1, wherein the metallic foil is manufactured from aluminum to enable plastic deformation.

3. The resealable package as set forth in claim 1, wherein the metallic foil has a thickness of between 0.1 mm to 1 mm to enable plastic deformation of the resealable package.

4. The resealable package as set forth in claim 1, wherein the two bonding corners are triangular in shape to define the funnel

5. The resealable package as set forth in claim 4, wherein the top portion includes two ends with notches to enable the top portion to shear and open the resealable packaging by exposing the dispensing slot.

6. The resealable package as set forth in claim 5, wherein the top flap folds along a folding line to reseal the resealable package.

7. The resealable package as set forth in claim 1, wherein the resealable package enclosed crystalline cannabinoids and the front layer is transparent to reveal the crystalline cannabinoids.

8. The resealable package as set forth in claim 1, wherein the resealable package encloses crystalline cannabinoids and the front layer is translucent to reveal the crystalline cannabinoids.

9. The resealable package as set forth in claim 1, wherein the resealable package enclosed crystalline cannabinoids and the front layer is translucent and tinted to reveal the crystalline cannabinoids with an aesthetically desirable tint.

10. The resealable package as set forth in claim 1, wherein the resealable package enclosed crystalline cannabinoids and the front layer is translucent and coated with a ultraviolet filter to reveal the crystalline cannabinoids with an aesthetically desirable tint.

11. The resealable package as set forth in claim 4, wherein the resealable package enclosed crystalline cannabinoids and the back layer is reflective to inhibit entry of light into the resealable package from the back side.

12. The resealable package as set forth in claim 4, wherein the ethylene is linear low density polyethylene and the line is defined in the high density polyethylene to enable folding along the line.

13. The resealable package as set forth in claim 1, wherein the ethylene is high density polyethylene and the line is defined in the high density polyethylene to enable folding along the line.

14. The resealable package as set forth in claim 1, wherein the front layer is manufactured from polyethylene terephthalate (PET), which resists chemical interactions with crystallized cannabinoids.

15. The resealable package as set forth in claim 14, wherein the front layer is transparent to reveal crystallized cannabinoids within the resealable packaging.

16. The resealable package as set forth in claim 1, wherein the resealable packaging encloses crystallized cannabinoids and the back layer includes transparent polyethylene and the metallic coating to enable the metallic coating to reflect light within the resealable packaging to highlight the crystallized cannabinoids in the packaging.

17. A method for sealing crystalline cannabinoids in a resealable package, comprising:
a) providing a resealable package having a metallic back layer with a back layer periphery and a front layer having a front layer periphery, at least a portion of the front layer being non-opaque to reveal contents of the resealable package;
b) providing crystalline cannabinoids between the back layer and the front layer;
c) sealing the crystalline cannabinoids between the back layer and the front layer;
d) the back layer and the front layer define a top edge having two bonding corners, the top edge defines a center line extending across the top edge, the two bonding corners and the top edge define a dispensing slot between the two bonding corners;
e) the method includes tearing the top edge along the center line to expose the dispensing slot to enable the enclosed crystalline cannabinoids to be precisely dispensed via the dispensing slot.

18. The method of claim 17, further comprising:
pouring the enclosed crystalline cannabinoids into a smoking device selected from the group comprising a pipe and rolling paper.

19. The method of claim 18, further comprising:
folding the top edge and the two bonding corners against the resealable package into a folded orientation to seal the resealable package and thereby prevent the enclosed crystalline cannabinoids from escaping the resealable package via the dispensing slot, the metallic back layer being rigid enough to normally maintain the folded orientation of the resealable packaging.

20. The method of claim 19, further comprising:
unfolding the top edge and the two bonding corners to open the resealable package and dispensing at least some of the enclosed crystalline cannabinoids via the dispensing slot.
